(19) United States
(12) Patent Application Publication
(10) Pub. No.: US 2019/0381938 A1
(43) Pub. Date: Dec. 19, 2019

(54) REARVIEW MIRROR ASSEMBLY HAVING AUTOMATIC ADJUSTMENT RESPONSIVE TO EYE-TRACKING

(71) Applicant: Gentex Corporation, Zeeland, MI (US)

(72) Inventor: Craig H. Hopkins, Untereisesheim (DE)

(21) Appl. No.: 16/444,361

(22) Filed: Jun. 18, 2019

Related U.S. Application Data
(60) Provisional application No. 62/686,334, filed on Jun. 18, 2018.

(51) Int. Cl. B60R 1/02; G06F 3/01; G06K 9/00

(52) U.S. Cl. CPC B60R 1/025; G06K 9/00845; G06F 3/013

(57) ABSTRACT

A rearview mirror assembly for a vehicle includes a mirror element having a position that is movable; at least one motorized actuator for adjusting the position of the mirror element in response to a control signal; an image sensor for sensing the position of at least one of a driver's head and eyes; and a controller coupled to the image sensor and configured to track the position of the at least one of a driver's head and eyes and to determine if the position has changed, the controller also coupled to the at least one motorized actuator and configured to supply a control signal to cause the at least one motorized actuator to adjust the position of the mirror element when the controller determines that the position of the at least one of a driver's head and eyes has changed.

### CROSS-REFERENCE TO RELATED APPLICATION

This application claims priority to and the benefit under 35 U.S.C. § 119(e) of U.S. Provisional Patent Application No. 62/686,334, filed on Jun. 18, 2018, entitled “REARVIEW MIRROR ASSEMBLY HAVING AUTOMATIC ADJUSTMENT RESPONSIVE TO EYE-TRACKING,” by Craig Hayes Hopkins, the entire disclosure of which is incorporated herein by reference.

### TECHNOLOGICAL FIELD

The present disclosure relates generally to a rearview mirror assembly for a vehicle and more particularly, an automatic position adjustment mechanism for a rearview mirror assembly.

### SUMMARY

According to an aspect of the present disclosure, a rearview mirror assembly for a vehicle is provided. The rearview mirror assembly comprises: a mirror element having a position that is movable; at least one motorized actuator for adjusting the position of the mirror element in response to a control signal; an image sensor for sensing the position of at least one of a driver's head and eyes; and a controller coupled to the image sensor and configured to track the position of the at least one of a driver's head and eyes and to determine if the position has changed, the controller also coupled to the at least one motorized actuator and configured to supply a control signal to cause the at least one motorized actuator to adjust the position of the mirror element when the controller determines that the position of the at least one of a driver's head and eyes has changed.

According to another aspect of the present disclosure, a method is provided of automatically adjusting a position of a mirror element of a rearview mirror assembly for a vehicle. The method comprising: providing at least one motorized actuator for adjusting the position of the mirror element in response to a control signal; providing an image sensor for sensing the position of at least one of a driver's head and eyes; using the image sensor to track the position of the at least one of a driver's head and eyes and to determine if the position has changed; and using the at least one motorized actuator to adjust the position of the mirror element when the position of the at least one of a driver's head and eyes has changed.

According to another aspect of the present disclosure, a rearview mirror assembly for a vehicle is provided. The rearview mirror assembly comprises: a mirror element having a position that is movable; at least one motorized actuator for adjusting the position of the mirror element in response to a control signal; an image sensor for sensing the position of at least one of a driver's head and eyes; and a controller coupled to the image sensor and configured to track the position of the at least one of a driver's head and eyes and to determine if the position has changed, the controller also coupled to the at least one motorized actuator and configured to supply a control signal to cause the at least one motorized actuator to adjust the position of the mirror element by an amount corresponding to the change in the position of the at least one of a driver's head and eyes so as to maintain a field of view seen by the driver.

These and other features, advantages, and objects of the present device will be further understood and appreciated by those skilled in the art upon studying the following specification, claims, and appended drawings.

### BRIEF DESCRIPTION OF THE DRAWINGS

FIG. 1 is an illustrative view of a mirror assembly comprising an eye-tracking apparatus;

FIG. 2 is a schematic view of various horizontal mirror fields corresponding to various locations of the eyes of a driver of a vehicle;

FIG. 3 is a schematic view of various vertical mirror fields corresponding to various locations of the eyes of a driver of a vehicle; and

FIG. 4 is block diagram of a system incorporating an eye-tracking apparatus disposed in a mirror assembly in accordance with the disclosure.

### DETAILED DESCRIPTION OF EMBODIMENTS

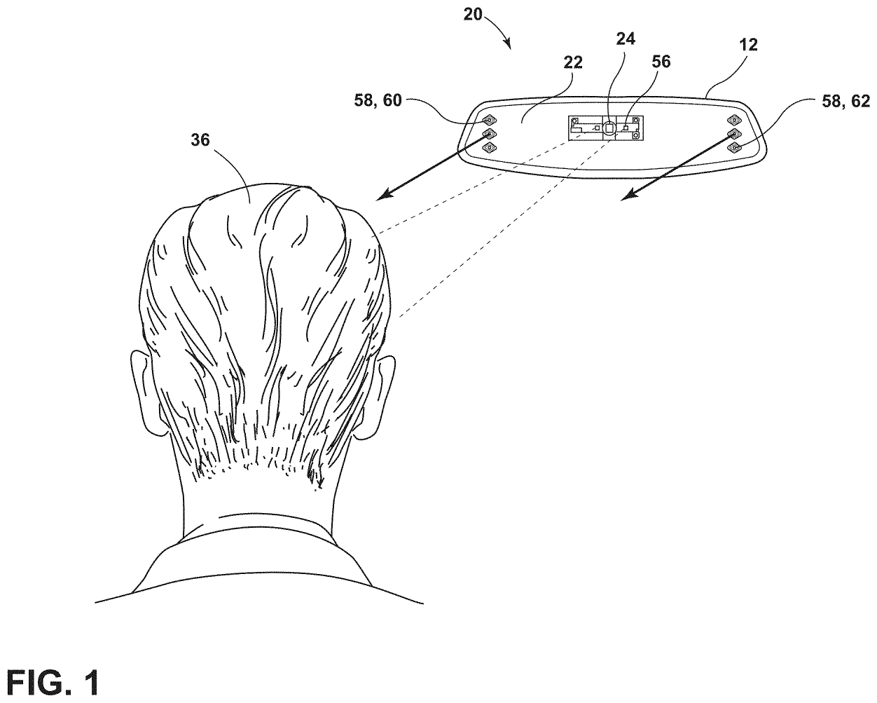

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Rearview mirror assemblies are known that are capable of automatic adjustment of the position of the mirror element or mirror housing in response to detection of glare from the rear of the vehicle. These mirror assemblies include actuators that tilt a prism mirror element upwards so that the primary reflection from the prism mirror element reflects towards the headliner of the vehicle and a dimmer secondary image is reflected towards the driver's eyes when excessive glare is detected by a rearward facing glare sensor. Examples of such mirror assemblies are disclosed in U.S. Pat. Nos. 4,443,057 and 4,488,777, the entire disclosures of which are incorporated herein by reference.

The position of a rearview mirror assembly often is adjusted for each driver that may drive that particular vehicle based upon a “nominal” position of the driver's eyes when the driver first gets in the vehicle. However, during driving (particularly on longer trips) the driver might slouch into the seat and thus the position of the driver's eyes is correspondingly lower. Further, the driver may adjust the seat up, down, forward or backward which will also cause a shift in the positon of the driver's eyes. When the position of the driver's eyes shifts, so does the field of view of the scene reflected by the mirror element to the driver. Accordingly, the driver does not always see the field of view that he or she wishes to see unless the driver consistently manually adjusts the position of the mirror element.

The rearview mirror assembly described herein is configured to detect and track the position of the driver's eyes and automatically adjusts the position of the mirror element. By “adjusts the position of the mirror element” it should be understood that this means that the mirror element itself may be tilted while the mirror housing remains stationary, or that the mirror housing is tilted and the mirror element tilts as a result. The adjustment may not only be a vertical adjustment to the field of view, but may also be a horizontal adjustment if so desired.

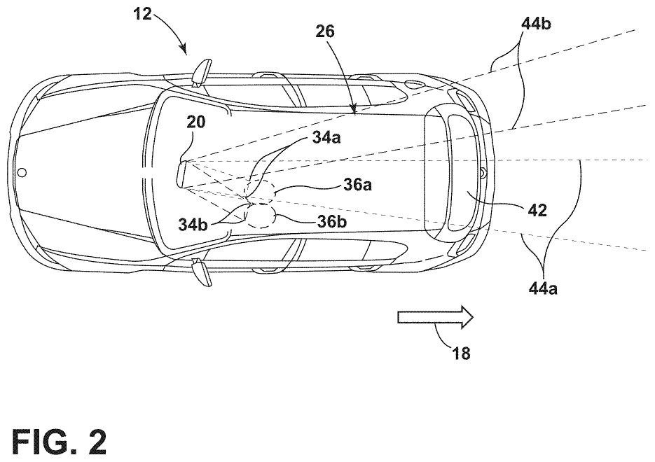

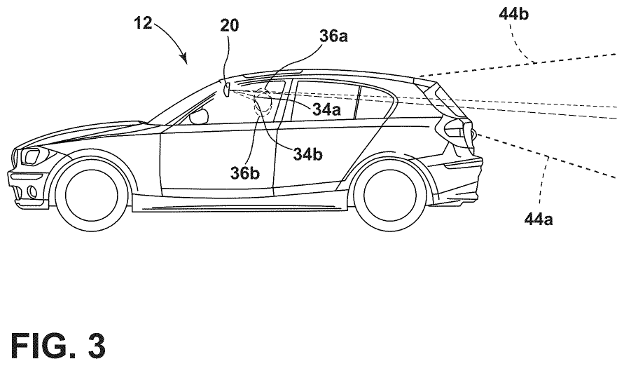

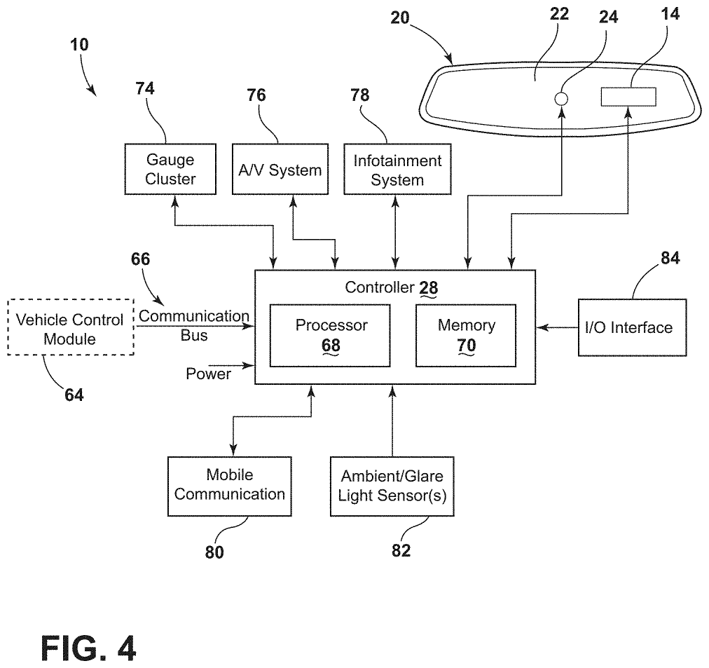

Referring now to FIG. 1, reference numeral 20 indicates a rearview mirror assembly 20 for a vehicle 12 (FIG. 2). The rearview mirror assembly 20 includes mirror element 22 and an image sensor 24 directed toward an interior 26 of the vehicle 12 and configured to capture image data of an object that, in an example, may include the eyes 34 or head 36 (both the eyes 34 and head 36 being generally indicated with respect to various identified positions thereof, designated as eyes 34a, 34b, etc. and head 36a, 36b, etc.) of a driver of vehicle 12. A controller 28 (FIG. 4) is in communication with the image sensor 24 to determine a position of the object (e.g., the eyes 34 or head 36 of the driver) within the image data and is also in communication with at least one actuator 14 (FIG. 3).

It is noted that the controller 28, as described herein, can be any suitable component or structure, including multiple, connected components or structures, within or associated with vehicle 12 that can detect the position of an object (e.g., the head 36 or eyes 34 of a driver), and control the actuator(s) 14 to adjust the position of the mirror element 22, according to the scheme disclosed herein. By way of example, controller 28 may be or include specific functionality within a computer system on-board vehicle 12. Further, controller 28 may comprise dedicated computer chips (e.g., application-specific integrated circuits) respectively connected with the image sensor 24, and further in communication at least with each other.

Referring to FIG. 2, a schematic depiction is shown in which the head 36 of a driver of vehicle 12 is shown in various positions 36a and 36b with respect to the rearview mirror assembly 20. As discussed herein, such a rearview mirror assembly 20 can be considered as a reflective rearview mirror that the driver uses to view a reflected image out of a rear windshield 42 of vehicle 12 and to the rear of vehicle 12 in direction 18. As illustrated, the driver has a field of view toward the rear of vehicle 12 that corresponds to a mirror field 44 determined by incidence lines taken from the respective eyes 34 of the driver to the corresponding edges of the reflective surface of mirror element 22 and corresponding reflection lines that, according to general optics principles, are at an equal angle to the incidence lines about a plane normal to the reflective surface. In this manner, the particular mirror field 44 and the accompanying portion of the area to the rear of vehicle 12 viewable through the mirror assembly 20 can be adjusted by changing the particular angle of the mirror element 22 itself or by the driver moving his or her head 36 and, thereby, changing the angles of the incidence lines from the eyes 34 to the mirror element 22.

In this type of arrangement, it is common for the driver to position the mirror element 22 to correspond with the view that the driver would like to have available using mirror assembly 20 when the driver's head 36 is in a comfortable, neutral seating position. The view that the driver has in the neutral seating position when the driver's head 36 is in position 36a in FIG. 2, is hereafter referred to as a neutral field of view 44a. During driving, the driver may move his or her head 36, such as from a position 36a in FIGS. 2 and 3 to a position 36b, which may unintentionally provide a different view by an adjusted mirror field of view 44, such as from mirror field of view 44a to mirror field of view 44b, which is shown having moved both horizontally in FIG. 2 and vertically in FIG. 3.

The rearview mirror assembly 20 can accommodate the driver's head movement by tracking the position of the driver's head 36 or, specifically, the eyes 34 of the driver with respect to mirror assembly 20 and may adjust the position of the mirror element 22 to maintain a constant field of view regardless of the driver's head position. Such tracking can be done by positioning a marker within the interior 26 of vehicle 12 that can be located using sensor 24 (when included in mirror assembly 20) or using a magnetic or mechanical sensor embedded in the mounting structure of mirror assembly 20 that facilitates movement thereof. In an embodiment when a marker is positioned in interior 26 of vehicle 12, the controller 28 may be able to use head 36 or eye 34 tracking in combination with the tracking of the marker relative to the image sensor 24 to determine the desired mirror element adjustment directly.

The rearview mirror assembly 20 can continue to track the location of the head 36 or eyes 34 and can adjust the mirror element position according to movement of the head 36 or eyes 34. As shown, such mirror element adjustment can be both horizontal and vertical and can be generally in the same direction as the movement of the eyes 34. The adjustment can be calibrated in advance and/or can be adjustable by the driver.

In the embodiment depicted in FIG. 1, the sensor 24 can be included in mirror assembly 20. In such an arrangement, the position of the eyes 34 may vary depending on the orientation of mirror assembly 20. In a variation, sensor 24 may be located elsewhere in vehicle 12, such as in an overhead console adjacent mirror assembly 20 or the like.

The tracking functionality may utilize an infrared illumination of the area viewable by sensor 24. In one example, the controller 28 may be able to identify a “blob” that, based on various criteria, can be reasonably identified as the head 36 of the driver (i.e., based on general size and location criteria). As discussed above, the location of the eyes 34 can be inferred based on the head 36 location determined based on the blob detection. Again, the eye 34 position can be based on average eye 34 location relative to the identified head 36 and may scale for the size of the detected blob. Alternatively, the irises of the driver's eyes 34 may be specifically identified based on a specific reflection pattern and/or location principles similar to the blob detection noted above for head 36 identification.

Additionally, in some implementations, the mirror assembly 20 may comprise a plurality of light sources 58 configured to illuminate at least one iris of the operator of the vehicle 12. Such illumination may be optimized in conditions allowing for a high optical transmittance in the near infrared (NIR) range. In some embodiments, the disclosure may provide for mirror element 22 that may have a high light transmittance in the NIR range, for example wavelengths ranging from 810 nm to 850 nm in the optical spectrum, along at least a portion thereof.

As shown in FIG. 1, to provide for the tracking function, sensor 24 may be disposed proximate a rear (interior) surface of the mirror element 22. The image sensor 24 may correspond to, for example, a digital charge-coupled device (CCD) or complementary metal-oxide-semiconductor (CMOS) active pixel sensor, although it is not meant to be limited to these example devices. In the illustrated example, the sensor 24 may be in communication with at least one light source 58, which may correspond to one or more infrared emitters configured to output an emission of light in the NIR range. In this configuration, controller 28 or the sensor 24 may be configured to selectively activate the one or more infrared emitters corresponding to the at least one light source 58 to provide illumination such that an instantaneous location of the head 36 or eyes 34 may be determined and/or monitored. Alternatively, sensor 24 may be a “passive” sensor in that it does not require illumination. In one example, sensor 24 can be a heat sensor that can be used to track the head 36 of the driver. In such an embodiment, the light source 58, discussed above, may not be included in the mirror assembly 20.

When present, the infrared emitters or the light sources 58 may correspond to a plurality of infrared emitter banks 60, 62. Each of the infrared emitter banks 60, 62 may comprise a plurality of light emitting diodes, which may be grouped in a matrix or otherwise grouped and disposed behind the rear surface of the mirror element 22. In an embodiment, the plurality of light sources 58 may correspond to a first emitter bank 60 and a second emitter bank 62. The first emitter bank 60 may be configured to output the emission in the NIR range from a first side portion of the front (outside) surface of the mirror element 22. The second emitter bank 62 may be configured to output the emission in the NIR range from a second side portion of the front surface of the mirror element 22. In this configuration, the mirror assembly 20 may be configured to illuminate the eyes 34 of the driver such that the sensor 24 may discern the eyes 34 of the driver from within the image data received from sensor 24.

In an embodiment, each of the first emitter bank 60 and/or the second emitter bank 62 may correspond to more or fewer LEDs or banks of LEDs. In some embodiments comprising a variation of the mirror element 22 having a high level of transmittance in the NIR range at least in portion(s) overlying emitter banks 60, 62, fewer or less intense LEDs may be utilized. In some embodiments comprising a variation of the mirror element 22 having a lower level of transmittance in the NIR range, a greater number of or more intense LEDs may be utilized.

Sensor 24 may be disposed on a circuit 56, for example, a printed circuit board in communication with controller 28. Controller 28 may further be in communication with various devices that may be incorporated in the vehicle 12 via a communication bus 66 or any other suitable communication interface. Controller 28 may correspond to one or more processors or circuits, which may be configured to process image data received from sensor 24. In this configuration, the image data may be communicated from sensor 24 to controller 28. The controller 28 may process the image data with one or more algorithms configured to discern or otherwise identify the eyes 34 of the driver within the image data. Further detailed discussion of the controller 28 and the various devices that may be in communication therewith are discussed in reference to FIG. 4.

Referring to FIG. 4, a block diagram of a system 10 with additional components of an overall control system of vehicle 12 is shown. The controller 28 is shown in communication with mirror assembly 20, including sensor 24 and the actuator(s) 14 and may also be in communication with a vehicle control module 64 via a communication bus 66 of the vehicle 12. The communication bus 66 may be configured to deliver signals to the controller 28 identifying various vehicle states. For example, the communication bus 66 may be configured to communicate to the controller 28 a drive selection of the vehicle 12, an ignition state, a door open or ajar status, or the like. Such information and control signals may be utilized by the controller 28 to activate or adjust various states and/or control schemes of the system 10 and/or the mirror assembly 20.

The controller 28 may comprise a processor 68 having one or more circuits configured to receive the signals from the communication bus 66 and control the system 10. The processor 68 may be in communication with a memory 70 configured to store instructions to control operations of the system 10. For example, the controller 28 may be configured to store one or more characteristics or profiles utilized by the controller 28 to identify the eyes 34 of the driver of the vehicle 12 within the image data.

The controller 28 may further be in communication with the actuator(s) 14. In this manner, based on the identification of the eyes 34, the controller 28 may be configured to select a corresponding position for the mirror element 22. The controller 28 may further be in communication with one or more of a gauge cluster 74, an audio/video (A/V) system 76, an infotainment system 78, a media center, a vehicle computing system, and/or various other devices or systems of the vehicle 12.

In a further embodiment, the controller 28 may correspond to one or more processors or circuits and may be configured to further process the image data received from sensor 24. In this configuration, the controller 28 may process the image data with one or more algorithms configured to determine an identity of the operator of the vehicle 12. With the identity of the operator or one or more passengers of the vehicle identified, the controller 28 may further be operable to control various systems or functions of the vehicle 12, as discussed further in co-pending, commonly-assigned U.S. Patent Application Publication No. US 2017/0177935 A1, the entire disclosure of which is incorporated by reference herein.

The controller 28 may further be in communication with ambient/glare light sensors 82. The ambient/glare light sensors 82 may be operable to communicate a light condition, for example a level of brightness or intensity of the ambient light proximate the vehicle 12 and/or glare level from behind the vehicle 12. In response to the level of the ambient light, the controller 28 may be configured to adjust a reflectivity level of the mirror element 22 if the mirror element 22 has an electrically variable reflectivity.

The controller 28 may further be in communication with an interface 84 configured to receive one or more inputs configured to control aspects of system 10. In some embodiments, the interface 84 may be combined with one or more devices of the vehicle 12. For example, the interface 84 may form a portion of the gauge cluster 74, the A/V system 76, the infotainment system 78, a display console and/or various input/output devices that may commonly be utilized in automotive vehicles (e.g. a steering switch, steering wheel controls, etc.). In this way, the disclosure provides for various control schemes for using system 10 in vehicle 12.

Although the above mirror assembly 20 has been described as tracking the eyes 34 of the driver and dynamically adjusting the mirror element position for that driver during the course of a trip, it may also be used to personalize the mirror element adjustment for various drivers that may use the vehicle 12. For example, if a first taller driver uses the vehicle 12, the mirror assembly 20 will detect the first driver's eyes and adjust the mirror element 22 accordingly. If a second shorter driver subsequently drives the vehicle, the mirror assembly 20 will detect the second driver's eyes and automatically tilt the mirror element 22 lower to accommodate the smaller driver without requiring manual movement.

The actuator(s) 14 for moving the mirror element 22 may have any conventional construction. Examples of such actuators are disclosed in U.S. Pat. Nos. 4,443,057 and 4,488,777, the entire disclosures of which are incorporated herein by reference.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A rearview mirror assembly for a vehicle, the rearview mirror assembly comprising:
a mirror element having a position that is movable;
at least one motorized actuator for adjusting the position of the mirror element in response to a control signal;
an image sensor for sensing the position of at least one of a driver's head and eyes; and
a controller coupled to the image sensor and configured to track the position of the at least one of a driver's head and eyes and to determine if the position has changed, the controller also coupled to the at least one motorized actuator and configured to supply a control signal to cause the at least one motorized actuator to adjust the position of the mirror element when the controller determines that the position of the at least one of a driver's head and eyes has changed.

2. The rearview mirror assembly of claim 1, wherein the controller causes the at least one motorized actuator to adjust the position of the mirror element by an amount corresponding to the change in the position of the at least one of a driver's head and eyes so as to maintain a field of view seen by the driver.

3. The rearview mirror assembly of claim 1 and further comprising a housing in which the mirror element is fixedly positioned, wherein the at least one motorized actuator adjusts the position of the mirror element by adjusting the position of the housing.

4. The rearview mirror assembly of claim 1 and further comprising a housing in which the mirror element is moveably positioned, wherein the at least one motorized actuator adjusts the position of the mirror element without adjusting the position of the housing.

5. The rearview mirror assembly of claim 1, wherein the at least one motorized actuator includes a first motorized actuator for adjusting a horizontal position of the mirror element in response to a horizontal control signal, and a second motorized actuator for adjusting a vertical position of the mirror element in response to a vertical control signal.

6. The rearview mirror assembly of claim 1 and further comprising a housing in which the mirror element is positioned, wherein the image sensor is positioned within the housing.

7. The rearview mirror assembly of claim 1 and further including at least one light source for illuminating the at least one of a driver's head and eyes.

8. The rearview mirror assembly of claim 7, wherein the at least one light source outputs emissions in the NIR range.

9. The rearview mirror assembly of claim 1 and further comprising a glare light sensor coupled to the controller for sensing glare level behind the vehicle, wherein the mirror element has an electrically variable reflectivity that is varied in response to the detected glare level.

10. A method of automatically adjusting a position of a mirror element of a rearview mirror assembly for a vehicle, the method comprising:
providing at least one motorized actuator for adjusting the position of the mirror element in response to a control signal;
providing an image sensor for sensing the position of at least one of a driver's head and eyes;
using the image sensor to track the position of the at least one of a driver's head and eyes and to determine if the position has changed; and
using the at least one motorized actuator to adjust the position of the mirror element when the position of the at least one of a driver's head and eyes has changed.

11. The method of claim 10, wherein the at least one motorized actuator to adjusts the position of the mirror element by an amount corresponding to the change in the position of the at least one of a driver's head and eyes so as to maintain a field of view seen by the driver.

12. The method of claim 10, wherein the step of using the at least one motorized actuator to adjust the position of the mirror element includes adjusting the mirror element in both a horizontal and vertical direction.

13. The method of claim 10 further including illuminating the at least one of a driver's head and eyes with near infrared emissions.

14. A rearview mirror assembly for a vehicle, the rearview mirror assembly comprising:
a mirror element having a position that is movable;
at least one motorized actuator for adjusting the position of the mirror element in response to a control signal;
an image sensor for sensing the position of at least one of a driver's head and eyes; and
a controller coupled to the image sensor and configured to track the position of the at least one of a driver's head and eyes and to determine if the position has changed, the controller also coupled to the at least one motorized actuator and configured to supply a control signal to cause the at least one motorized actuator to adjust the position of the mirror element by an amount corresponding to the change in the position of the at least one of a driver's head and eyes so as to maintain a field of view seen by the driver.

15. The rearview mirror assembly of claim 14 and further comprising a housing in which the mirror element is fixedly positioned, wherein the at least one motorized actuator adjusts the position of the mirror element by adjusting the position of the housing.

16. The rearview mirror assembly of claim 14 and further comprising a housing in which the mirror element is moveably positioned, wherein the at least one motorized actuator adjusts the position of the mirror element without adjusting the position of the housing.

17. The rearview mirror assembly of claim 14, wherein the at least one motorized actuator includes a first motorized actuator for adjusting a horizontal position of the mirror element in response to a horizontal control signal, and a second motorized actuator for adjusting a vertical position of the mirror element in response to a vertical control signal.

18. The rearview mirror assembly of claim 14 and further comprising a housing in which the mirror element is positioned, wherein the image sensor is positioned within the housing.

19. The rearview mirror assembly of claim 14 and further including at least one light source for illuminating the at least one of a driver's head and eyes.

20. The rearview mirror assembly of claim 19, wherein the at least one light source outputs emissions in the NIR range.
